(19) United States
(12) Patent Application Publication
(10) Pub. No.: US 2024/0219619 A1
(43) Pub. Date: Jul. 4, 2024

(54) DISPLAY DEVICE

(71) Applicant: Japan Display Inc., Tokyo (JP)

(72) Inventor: Makoto MIYAO, Tokyo (JP)

(21) Appl. No.: 18/394,025

(22) Filed: Dec. 22, 2023

(30) Foreign Application Priority Data
Dec. 28, 2022 (JP) 2022-211499

(51) Int. Cl. F21V 8/00; G02F 1/1335; G02F 1/13357

(52) U.S. Cl. CPC G02B 6/0036; G02F 1/133524; G02F 1/133615

(57) ABSTRACT

A display device includes a first substrate having a first front surface and a first back surface opposite to the first front surface, a liquid crystal layer arranged on the first front surface of the first substrate, a light guide plate having a first main surface facing the first front surface, a second main surface opposite to the first main surface, and side surfaces intersecting with the first main surface and the second main surface, and a light source unit having a plurality of light emitting elements arranged to face the side surface of the light guide plate, and a surface roughness of a first side surface of the light guide plate facing the light source unit is larger than surface roughnesses of the side surfaces other than the first side surface.

### CROSS REFERENCE TO RELATED APPLICATIONS

The present application claims priority to Japanese Patent Application No. 2022-211499 filed on Dec. 28, 2022, the disclosure of which is incorporated herein by reference.

### TECHNICAL FIELD OF THE INVENTION

The present invention relates to a display device having a light guide plate.

### BACKGROUND OF THE INVENTION

As a display device having a liquid crystal layer, a transparent display device in which a side surface of a transparent substrate is arranged so as to face a light emitting element and the light emitted from the light emitting element is made to enter the transparent substrate and is guided therein has been known. For example, Japanese Unexamined Patent Application Publication No. 2020-177731 (Patent Document 1) discloses a display device including a light emitting element and a cover glass having a first side surface facing the light emitting element and a second side surface opposite to the first side surface, wherein a reflective material is provided on the second side surface of the cover glass, a reflective material is not provided on the first side surface, and a surface roughness of the second side surface is made larger than that of the first side surface, thereby suppressing the light entering from a side surface of a light guide plate from leaking to the outside from an opposite side of this side surface and improving light utilization efficiency.

### SUMMARY OF THE INVENTION

The inventor of this application has been developing a transparent display device with which an observer can recognize a display image and a background overlapping each other. In the case of a transparent display device, each of front and back surfaces needs to have the property of transmitting visible light. Therefore, a light source unit for displaying images is arranged on a side surface of a light guide plate. The light emitted from the light source unit enters from the side surface of the light guide plate, is scattered by a liquid crystal layer while being diffused inside a liquid crystal panel, and is emitted to the outside of the liquid crystal panel. The observer can recognize the image by perceiving the emitted light.

Incidentally, in recent years, a light emitting diode element (LED) has been used in general as a light source constituting a light source unit. The LED has a high condensing property for incident light and is preferable in terms of ensuring brightness, but the light emitted by the LED is observed as bright lines with high brightness in the shape of stripes near a light entrance portion of the light guide plate in some cases. Therefore, an object of the present invention is to provide a display device capable of suppressing the generation of such stripe-shaped light near the light entrance portion, thereby improving the image display quality.

A display device according to an embodiment of the present invention includes a first substrate having a first front surface and a first back surface opposite to the first front surface, a liquid crystal layer arranged on the first front surface of the first substrate, a light guide plate having a first main surface facing the first front surface, a second main surface opposite to the first main surface, and side surfaces intersecting with the first main surface and the second main surface, and a light source unit having a plurality of light emitting elements arranged to face the side surface of the light guide plate, and a surface roughness of a first side surface of the light guide plate facing the light source unit is larger than surface roughnesses of the side surfaces other than the first side surface.

### BRIEF DESCRIPTIONS OF THE DRAWINGS

FIG. 1 is an explanatory diagram showing a positional relationship in a case where an observer on one side of a transparent display panel visually recognizes a background on the opposite side through the transparent display panel;

FIG. 2 is an explanatory diagram showing an example of the background visually recognized through the transparent display panel;

FIG. 3 is a perspective view showing an example of a schematic configuration of the transparent display panel shown in FIG. 1;

FIG. 4 is a cross-sectional view taken along the line A-A in FIG. 3;

FIG. 5 is a circuit block diagram showing an example of a circuit provided in the transparent display panel in FIG. 3;

FIG. 6 is a side view for explaining a configuration near a light entrance portion of a light guide plate in the transparent display panel in FIG. 3;

FIG. 7 is a side view for explaining a configuration near a light entrance portion of a light guide plate in a modification of the transparent display panel in FIG. 3;

FIG. 8 is a diagram for explaining a schematic configuration of a modification in a present embodiment;

FIG. 9 is a diagram for explaining a schematic configuration of another modification in the present embodiment;

FIG. 10 is a diagram showing a state of a light entrance side region of a display panel in an example; and

FIG. 11 is a diagram showing a state of a light entrance side region of a display panel in a comparative example.

### DESCRIPTIONS OF THE PREFERRED EMBODIMENTS

Hereinafter, an embodiment of the present invention will be described with reference to drawings. Note that the disclosure is merely an example, and it is a matter of course that any alteration that is easily made by a person skilled in the art while keeping a gist of the present invention is included in the range of the present invention. In addition, the drawings schematically illustrate a width, a thickness, a shape, and the like of each portion as compared with actual aspects in order to make the description clearer, but the drawings are merely examples and do not limit the interpretation of the present invention. Further, the same elements as those described in relation to the foregoing drawings are denoted by the same or related reference characters in this specification and the respective drawings, and detailed descriptions thereof will be omitted as appropriate.

### [Display Device]

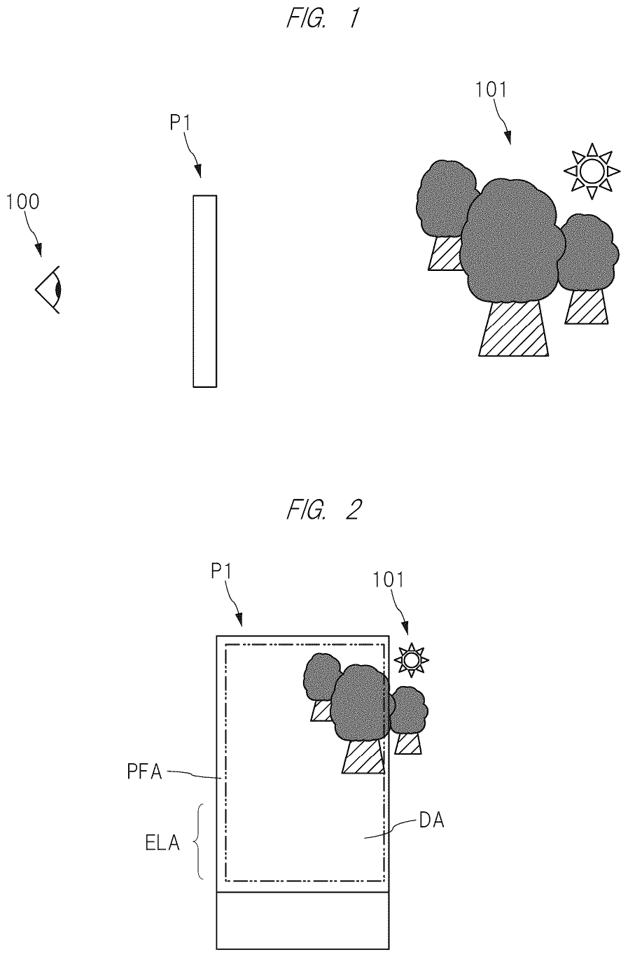

The display device according to the present embodiment is a transparent display device, and first, a schematic configuration of this display device will be described. FIG. 1 is an explanatory diagram showing a positional relationship in a case where an observer on one side of a display panel P1 visually recognizes a background on the opposite side through the display panel P1. FIG. 2 is an explanatory diagram showing an example of the background visually recognized through the display panel P1.

As shown in FIG. 1, when an observer 100 looks from one side of the display panel P1 to the other side, the background 101 is visually recognized through the display panel P1. As shown in FIG. 2, it is preferable that the display region DA and the peripheral region PFA outside the display region DA both have visible light transparency because the entire background 101 can be visually recognized without any sense of discomfort. Note that the peripheral region PFA does not need to have visible light transparency. Here, the boundary between the display region DA and the peripheral region PFA is indicated by a double-dot-dashed line.

Further, a light entrance side region ELA which is the region to be an issue in the present embodiment is also shown in FIG. 2. In FIG. 2, the case in which a light source in the display panel P1 is arranged on the lower side of the drawing and an image is displayed by guiding a light source light from the lower side to the upper side is assumed, and it can be said that the light entrance side region ELA is a region of the display region DA that is close to the light source device.

The display panel P1 used here may be any transparent display panel as long as it has a transparent glass plate or the like and can display an image and the background can be seen therethrough, and known transparent display panels can be used as a basic configuration without restrictions. Examples of the transparent display panel include a liquid crystal display panel. This display panel P1 has a configuration in which light from a light source that enters a liquid crystal layer via a light guide plate or external light that enters the liquid crystal layer is transmitted and diffused by the liquid crystal layer, and the light source is not present on a flat surface of a substrate.

In the present embodiment, the case in which a transparent display panel (liquid crystal display panel) configured to display an image by using scattering of visible light by liquid crystal molecules is used as the display panel P1 will be described as an example below.

Here, a liquid crystal display panel is a device that forms a display image by changing the orientation of molecules contained in a liquid crystal layer, and it requires a light source. In the following, a mode in which a light source is provided on the side of a display panel including a liquid crystal layer will be described as an example.

### <Display Panel>

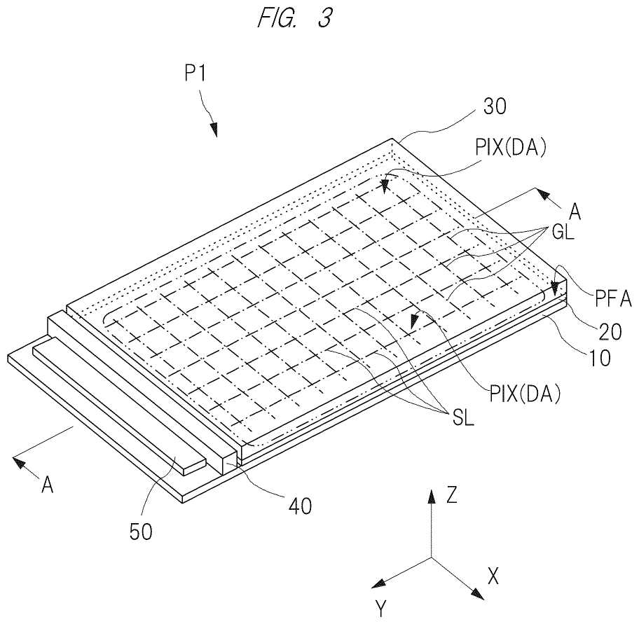

First, the configuration of the display panel will be described. FIG. 3 is a perspective view showing an example of the display panel P1 used in the present embodiment.

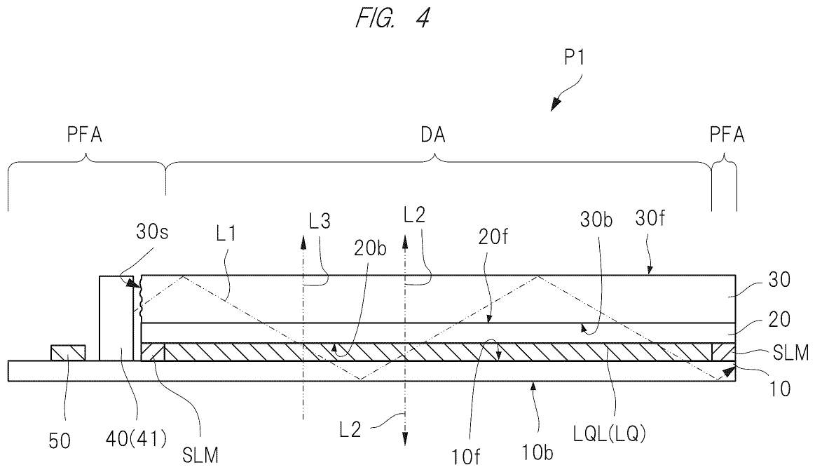

In FIG. 3, a part of the signal wiring that transmits signals for driving the liquid crystal (specifically, gate line GL and source line SL) in the circuit provided in the display panel P1 is schematically shown by dot-dashed lines. In the following description with reference to the drawings including FIG. 3, the direction along the thickness direction of the display panel P1 is the Z direction, the direction in which one side of the display panel P1 extends in the X-Y plane orthogonal to the Z direction is the X direction, and the direction that intersects with the X direction in the X-Y plane is the Y direction. FIG. 4 is a cross-sectional view taken along the line A-A in FIG. 3.

As shown in FIG. 3, the display panel P1 of the present embodiment includes a substrate (array substrate) 10, a counter substrate 20, a light guide plate 30, a side light source device 40, and a drive circuit 50. The display panel P1 may include, for example, a control circuit, a flexible substrate connected to the display panel P1, a housing, and the like, in addition to the respective parts provided in the display panel P1 shown in FIG. 3. In FIG. 3, illustration of parts other than the display panel P1 is omitted. In the display panel P1, an image is formed in the display region DA in accordance with an input signal supplied from outside.

Although the display region DA of the display panel P1 shown in FIG. 3 is a quadrangle, the display region may have a shape other than a quadrangle such as a polygon or a circle. The display region DA is an effective region in which the display panel P1 displays an image in plan view showing the display surface. Each of the substrate 10, the counter substrate 20, and the light guide plate 30 is located at a position overlapping the display region DA in plan view. The side light source device 40 and the drive circuit 50 are each mounted on the substrate 10.

As shown in FIG. 4, the display panel P1 includes the substrate 10 and the counter substrate 20 that are bonded so as to face each other with a liquid crystal layer LOL interposed therebetween. The substrate 10, the counter substrate 20, and the light guide plate 30 are arranged in the Z direction which is the thickness direction of the display panel P1. In other words, the substrate 10, the counter substrate 20, and the light guide plate 30 face each other in the thickness direction (Z direction) of the display panel P1.

Here, because of the configuration above, the substrate 10 has a front surface (main surface, surface) 10f facing the liquid crystal layer LOL (and the counter substrate 20) and a back surface 10b, and the counter substrate 20 has a back surface (main surface, surface) 20b facing the front surface 10f of the substrate 10 (and liquid crystal layer LOL) and a front surface (main surface, surface) 20f that is an opposite surface of the back surface 20b. Namely, the liquid crystal layer LOL is held between the substrate 10 and the counter substrate 20 (more specifically, it is sandwiched and held between the front surface 10f of the substrate 10 and the back surface 20b of the counter substrate 20). Furthermore, the light guide plate 30 has a back surface (main surface, surface) 30b facing the front surface 20f of the counter substrate 20 and a front surface (main surface, surface) 30f that is an opposite surface of the back surface 30b.

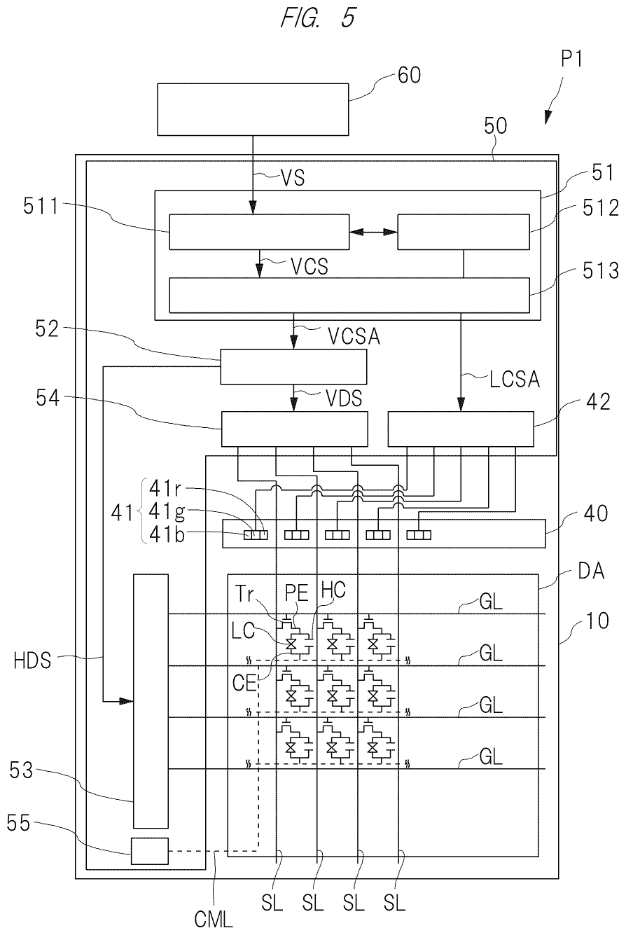

The substrate 10 is an array substrate in which a plurality of transistors (transistor elements) as switching elements (active elements) Tr (see FIG. 5) is arranged in an array. Further, the counter substrate 20 is a substrate provided on the side of the display surface, and is a substrate arranged to face the array substrate.

The liquid crystal layer LOL including a liquid crystal LQ is an optical modulation element. The display panel P1 has a function of modulating the light passing therethrough by controlling the state of an electric field formed around the liquid crystal layer LOL via the above-described switching element. When this display panel P1 is viewed in plan view, the display region DA of each of the substrate 10, the counter substrate 20, and the light guide plate 30 overlaps the liquid crystal layer LOL as shown in FIG. 4.

Further, the substrate 10 and the counter substrate 20 are bonded together via a sealing portion (sealing material) SLM. As shown in FIG. 3 and FIG. 4, the sealing portion SLM (see FIG. 4) is arranged in the peripheral region PFA so as to surround the display region DA. As shown in FIG. 4, the liquid crystal layer LOL is present on the inner side of the sealing portion SLM. The sealing portion SLM serves as a seal that encloses the liquid crystal between the substrate 10 and the counter substrate 20. Further, the sealing portion SLM serves as an adhesive for bonding the substrate 10 and the counter substrate 20 together.

The light guide plate 30 is a member that is stacked on the counter substrate 20, and the light source light emitted from the side light source device 40 to be described later is guided inside the light guide plate 30. This light guide plate 30 is sometimes referred to as a cover glass because it is provided on the front surface side of the display panel P1.

The side light source device 40 includes a plurality of light source units 41. The light source unit 41 is arranged at a position facing a side surface 30s of the light guide plate 30. As schematically shown by a double-dot-dashed line in FIG. 4, the light source light L1 emitted from the light source unit 41 propagates in the direction away from the side surface 30s while being reflected by the back surface 10b of the substrate 10 and the front surface 30f of the light guide plate 30. In the propagation path of the light source light L1, the back surface 10b of the substrate 10 and the front surface 30f of the light guide plate 30 are interfaces between a medium with a large refractive index and a medium with a small refractive index. Therefore, when the incident angle at which the light source light L1 enters the front surface 30f and the back surface 10b is larger than the critical angle, the light source light L1 is totally reflected by the front surface 30f and the back surface 10b.

The liquid crystal LQ is a polymer-dispersed liquid crystal LC and contains a liquid crystalline polymer and liquid crystal molecules. The liquid crystalline polymer is formed into stripes, and the liquid crystal molecules are dispersed in the gaps of the liquid crystalline polymer. Each of the liquid crystalline polymer and liquid crystal molecules has optical anisotropy or refractive index anisotropy. The responsiveness of the liquid crystalline polymer to the electric field is lower than the responsiveness of liquid crystal molecules to the electric field. The orientation direction of the liquid crystalline polymer hardly changes regardless of the presence or absence of the electric field. On the other hand, in the state where a high voltage equal to or higher than the threshold voltage is applied to the liquid crystal LQ, the orientation direction of the liquid crystal molecules changes depending on the electric field.

In the state where no voltage is applied to the liquid crystal LQ, the optical axes of the liquid crystalline polymer and the liquid crystal molecules are parallel to each other, and the light source light L1 that has entered the liquid crystal layer LOL is hardly scattered and passes through the liquid crystal layer LOL (transparent state). In the state where a voltage is applied to the liquid crystal LQ, the optical axes of the liquid crystalline polymer and the liquid crystal molecules intersect with each other, and the light source light L1 that has entered the liquid crystal LQ is scattered in the liquid crystal layer LQL (scattering state).

The display panel P1 controls the transparent state and the scattering state by controlling the orientation of the liquid crystal LQ in the propagation path of the light source light L1. In the scattering state, the light source light L1 is emitted by the liquid crystal LQ as emitted light L2 to the outside of the display panel P1 from the back surface 10b and the front surface 30f. Further, a background light L3 that has entered from the side of the back surface 10b passes through the substrate 10, the liquid crystal layer LOL, the counter substrate 20, and the light guide plate 30, and is emitted to the outside from the front surface 30f. Although not shown, the same applies to the background light on the side of the front surface 30f that passes through the light guide plate 30, the counter substrate 20, the liquid crystal layer LOL, and the substrate 10 from the front surface 30f. The emitted light L2 and the background light L3 are visually recognized by an observer on the side of the front surface 30f. Therefore, the observer can recognize the emitted light L2 and the background light L3 in combination.

### (Circuit Configuration Example)

Next, a configuration example of a circuit provided in the display panel P1 shown in FIG. 3 will be described. FIG. 5 is a circuit block diagram showing an example of the circuit provided in the transparent display panel in FIG. 3. The wiring path connected to a common electrode CE shown in FIG. 5 is formed on, for example, the counter substrate 20 shown in FIG. 4. In FIG. 5, the wiring formed on the counter substrate 20 is illustrated by dotted lines. In the example shown in FIG. 5, a light source control unit 42 is included in the drive circuit 50. As a modification, the light source control unit 42 may be provided separately from the drive circuit 50. The light source control unit 42 is formed on, for example, a wiring board (not shown) that is connected to the side light source device 40 shown in FIG. 3, and is electrically connected to the light source unit 41 via the wiring board.

In the example shown in FIG. 5, the drive circuit 50 includes a signal processing circuit 51, a pixel control circuit 52, a gate drive circuit 53, a source drive circuit 54, and a common potential drive circuit 55. Further, the light source unit 41 includes light emitting diode elements 41r, 41g, and 41b serving as, for example, a red light source, a green light source, and a blue light source.

The signal processing circuit 51 includes an input signal analysis unit (input signal analysis circuit) 511, a storage unit (storage circuit) 512, and a signal adjustment unit 513. The display panel P1 includes a control unit 60 having a control circuit that controls image display, and an input signal VS is input to the input signal analysis unit 511 of the signal processing circuit 51 from the control unit 60 via a wiring path of a flexible wiring board (not shown) or the like. The input signal analysis unit 511 generates an input signal VCS by performing analysis processing based on the input signal VS input from the outside. The input signal VCS is, for example, a signal that determines what kind of gradation value is given to each pixel PIX (see FIG. 3) of the display panel P1 based on the input signal VS.

The signal adjustment unit 513 generates an input signal VCSA from the input signal VCS input from the input signal analysis unit 511. The signal adjustment unit 513 sends the input signal VCSA to the pixel control circuit 52 and sends a light source control signal LCSA to the light source control unit 42. The light source control signal LCSA is, for example, a signal that includes information of the amount of light of the light source unit 41 that is set in accordance with the input gradation value to the pixel PIX. For example, when a dark image is displayed, the amount of light of the light source unit 41 is set to be small. When a bright image is displayed, the amount of light of the light source unit 41 is set to be large.

The pixel control circuit 52 generates a horizontal drive signal HDS and a vertical drive signal VDS based on the input signal VCSA. For example, since the field sequential method is adopted for driving in the present embodiment, the horizontal drive signal HDS and the vertical drive signal VDS are generated for each color of light that the light source unit 41 can emit. The gate drive circuit 53 sequentially selects the gate lines GL of the display panel P1 (see FIG. 3) within one vertical scanning period based on the horizontal drive signal HDS. The order of selection of the gate lines GL is arbitrary. As shown in FIG. 3, a plurality of gate lines (signal wiring) GL extends in the X direction and is arranged along the Y direction.

The source drive circuit 54 supplies the gradation signal in accordance with the output gradation value of each pixel PIX (see FIG. 3) to each source line SL of the display panel P1 within one horizontal scanning period based on the vertical drive signal VDS. As shown in FIG. 3, the plurality of source lines (signal wiring) SL extends in the Y direction and is arranged along the X direction. One pixel PIX is formed at each intersection of the gate line GL and the source line SL. The switching element Tr (see FIG. 5) is formed at each portion where the gate line GL and the source line SL intersect. The plurality of gate lines GL and the plurality of source lines SL shown in FIG. 3 and FIG. 5 correspond to a plurality of signal wirings for transmitting the drive signal for driving the liquid crystal LQ shown in the drawing.

For example, film transistor is used as the switching element Tr shown in FIG. 5. The type of the thin film transistor is not particularly limited, and examples thereof include the following transistors. When classified based on the position of the gate, a bottom gate transistor and a top gate transistor can be presented. Further, when classified based on the number of gates, a single gate thin film transistor and a double gate thin film transistor can be presented. One of the source electrode and the drain electrode of the switching element Tr is connected to the source line SL, the gate electrode is connected to the gate line GL, and the other of the source electrode and the drain electrode is connected to one end of the capacitor of the polymer-dispersed liquid crystal LC (liquid crystal LQ shown in FIG. 4). One end of the capacitor of the polymer-dispersed liquid crystal LC is connected to the switching element Tr via the pixel electrode PE, and the other end is connected to a common potential wiring CML via the common electrode CE. Further, a holding capacitor HC is generated between the pixel electrode PE and a holding capacitor electrode electrically connected to the common potential wiring CML. Note that a common potential is supplied to the common potential wiring CML from the common potential drive circuit 55.

### (Light Entrance Surface of Light Guide Plate)

Next, the side light source device 40 having the light source unit 41 is arranged so as to face the side surface of the light guide plate 30 of the display panel P1 shown in FIG. 3, and the side surface of the light guide plate 30 facing the light source unit 41 will be described below.

A plurality of light source units 41 is usually arranged along a longitudinal direction (first direction) of the side light source device 40. It can also be said that the plurality of light source units 41 is arranged so as to face the side surface 30s of the light guide plate 30. For example, the light source unit 41 is configured to include the light emitting diode elements 41r, 41g, and 41b as shown in FIG. 5.

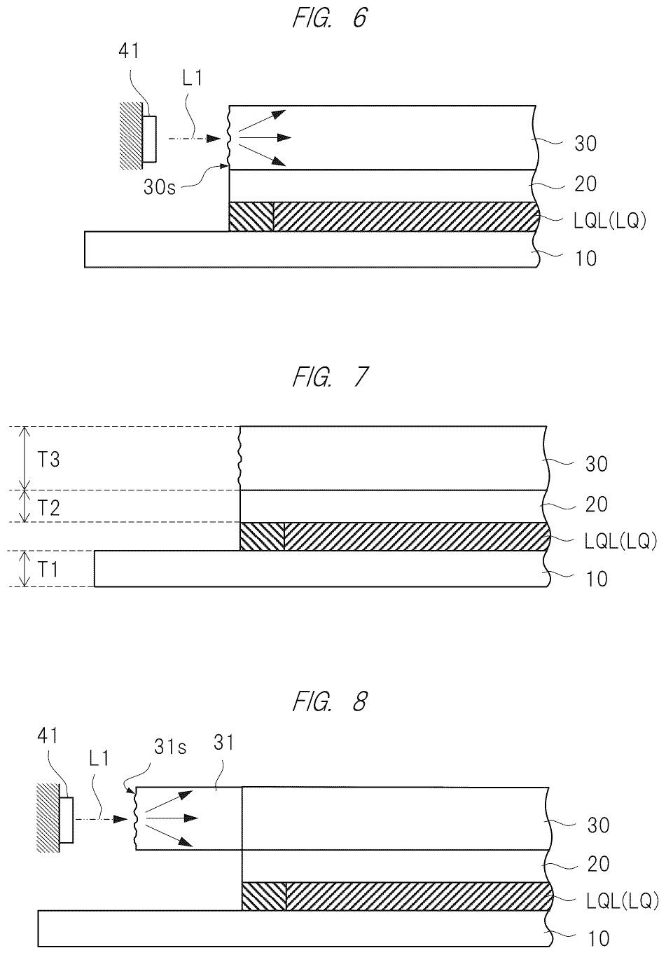

FIG. 6 is a diagram for explaining the arrangement relationship of the light guide plate 30 and the light source unit 41. Here, the display panel P1 in which the substrate 10 is disposed on the lower side and the light guide plate 30 is disposed on the upper side is shown in a side view. When viewed in this way, the light source unit 41 is arranged so as to face the side surface 30s of the light guide plate 30. Then, the light source light L1 emitted from the light source unit 41 is delivered to this side surface 30s, and the light source light L1 is guided in the light guide plate 30. Namely, the side surface 30s is a light entrance surface for the light source light L1 in the light guide plate 30.

Further, in the present embodiment, the side surface 30s facing the light source unit 41 is roughened, and the side surfaces other than the side surface 30s (the side surfaces not facing the light source unit 41) are mirror-finished. Namely, the surface roughness of the side surface 30s is made larger than those of the side surfaces other than the side surface 30s.

Here, the side surface 30s is a surface through which the light emitted from the light source unit 41 enters the light guide plate 30 as described above. Thus, by roughening this side surface 30s, the light source light L1 emitted from the light source unit 41 enters the light guide plate 30 while being scattered by the side surface 30s. Therefore, in the vicinity of the light entrance portion (the light entrance side region ELA) into which the light from the light source unit 41 is introduced, unevenness in brightness due to the light source light can be eliminated and the generation of stripe-shaped light can be suppressed.

In addition, in FIG. 6, the solid arrows after the light source light L1 enters the light guide plate 30 indicate that the light source light L1 is scattered, and it is thought that the brightness of the light observed near the light entrance portion is made even because the light source light L1 is scattered not only in the thickness direction but also in the planar direction.

Meanwhile, since the side surfaces of the light guide plate 30 other than the side surface 30s are mirror-finished, it is possible to suppress the light, which has entered the light guide plate 30 and been scattered, from being emitted to the outside, and it possible to improve the light utilization efficiency. Namely, as shown in FIG. 4, the light source light L1 that has entered the light guide plate 30 propagates in the direction away from the side surface 30s while being scattered by the roughened side surface 30s and reflected by the back surface 10b of the substrate 10 and the front surface 30f of the light guide plate 30. Then, the light source light L1 reaches the side surface opposite to the side surface 30s and the side surfaces intersecting with the side surface 30s, but since these side surfaces are mirror-finished, most of the light is reflected and further propagates inside the light guide plate 30 for use in image display.

Therefore, by roughening the side surface 30s of the light guide plate 30 and mirror-finishing the other side surfaces as in the present embodiment, the generation of stripe-shaped light observed in the light entrance side region ELA can be suppressed, and it is possible to maintain the light utilization efficiency.

Here, it is preferable that the surface roughness of the side surface 30s of the light guide plate 30 satisfies at least one of the conditions of a surface roughness Ra of 0.1 to 1.5 μm and a surface roughness Rz of 1.5 to 9.5 μm. In the side surface 30s, the above-described ranges of the surface roughness Ra and the surface roughness Rz may be simultaneously satisfied. Further, more preferable ranges of these surface roughnesses are the surface roughness Ra of 1.0 to 1.5 μm and the surface roughness Rz of 5.0 to 9.5 μm, respectively.

Further, it is preferable that the surface roughnesses of the side surfaces of the light guide plate 30 other than the side surface 30s satisfy at least one of the conditions of the surface roughness Ra of 0.02 μm or less and the surface roughness Rz of 0.05 to 0.2 μm. In the side surfaces other than the side surface 30s, the above-described ranges of the surface roughness Ra and the surface roughness Rz may be simultaneously satisfied. Further, more preferable ranges of these surface roughnesses are the surface roughness Ra of 0.01 μm or less and the surface roughness Rz of 0.05 to 0.1 μm, respectively.

The light guide plate 30 having such a roughened side surface can be formed as follows. For example, a roughened surface can be formed by chemically processing the side surface 30s of the light guide plate 30 with hydrofluoric acid. Alternatively, a roughened surface can be formed by mechanically processing the side surface 30s with a rotary grindstone having a grain size of #600 to #800. In this way, the display panel P1 can be formed using the light guide plate 30 processed to have the desired surface roughness.

Here, since the display device according to the present embodiment has the display panel P1 described above, the generation of stripe-shaped light can be suppressed, and at the same time, the brightness in the light entrance side region ELA of the display panel P1 can be improved owing to the scattering.

When the brightness is improved in the light entrance side region ELA, then the difference in brightness may increase between the light entrance side region ELA and a region further from the light source. In that case, the overall brightness of the display panel P1 becomes uneven, and a brightness gradient may occur. In order to prevent such a brightness gradient (to eliminate uneven brightness), it is preferable to increase the thickness of the light guide plate 30.

In order to suppress the occurrence of brightness gradient while exhibiting the effect described above, the thickness of the light guide plate 30 at this time is preferably in the range of 3 to 6.5 mm, more preferably 4.0 to 5.0 mm. The thickness of the light guide plate 30 mentioned here is the thickness of the portion indicated by thickness T3 in FIG. 7.

Further, the thickness of the substrate 10 and the thickness of the counter substrate 20 can be set as appropriate as long as it is possible to stably hold the liquid crystal layer LOL and clearly display an image including the background. From the viewpoint of ensuring such functions, the thickness of the substrate 10 and the thickness of the counter substrate 20 are preferably in the range of 0.5 to 0.7 mm, respectively. At this time, the thickness of the substrate 10 mentioned here is the thickness of the portion indicated by thickness T1 in FIG. 7, and the thickness of the counter substrate 20 mentioned here is the thickness of the portion indicated by thickness T2 in FIG. 7.

By satisfying the above-mentioned thickness ranges for each of the substrate, the counter substrate, and the light guide plate, the display device with good display quality capable of suppressing the generation of stripe-shaped light in the light entrance side region ELA and the unevenness in brightness between the light entrance side region ELA and the other region in the display region DA can be obtained.

Note that, in the display device according to the present embodiment described above, the case in which the counter substrate 20 and the light guide plate 30 are configured as separate structures and the light source light L1 is introduced into the light guide plate 30 is illustrated, but the light source light L1 may be made to enter only the counter substrate 20 or may be made to enter both the counter substrate 20 and the light guide plate 30. Further, as long as the respective functions of the counter substrate 20 and the light guide plate 30 can be exhibited, they may be collectively prepared as one substrate to constitute the display panel P1.

### Modification 1

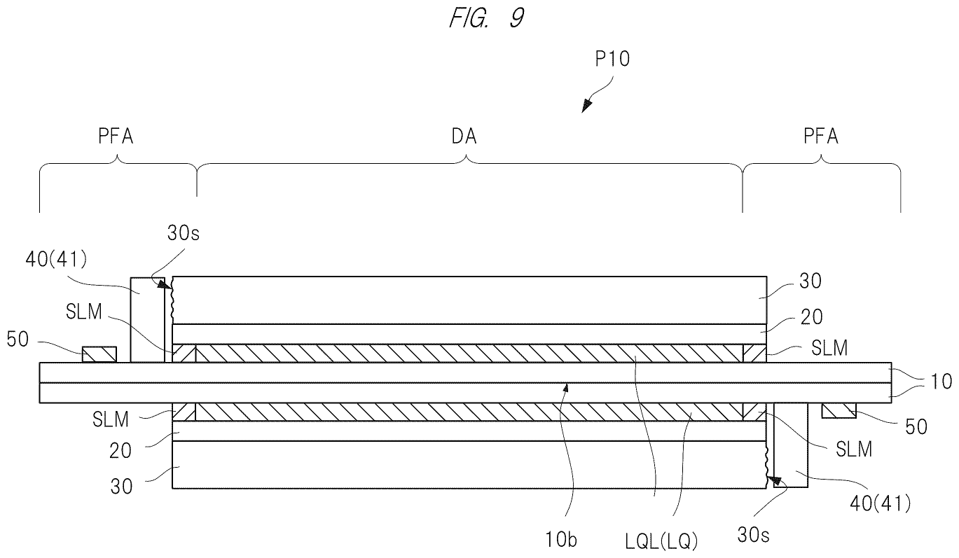

Note that, as shown in FIG. 8, a lens unit 31 may be provided as a part of the light guide plate 30 on the side close to the light source unit 41 (light entrance side). At this time, the lens unit 31 has a side surface 31s facing the light source unit 41, and a side surface opposite to the side surface 31s is arranged so as to be in contact with the light guide plate 30, so that the light source light emitted from the light source unit 41 can be introduced into the light guide plate 30 through the lens unit 31.

This lens unit 31 can be composed of a plurality of lenses arranged in the X direction, or can be composed of a single lens extending in the X direction. The lens mentioned here is an optical member having a function of diverging or converging light by utilizing a difference in refractive index, among light guide members that transmit visible light. The lens unit 31 functions as a type of light guide plate, and the light guide plate is constituted using the light guide plate 30 and the lens unit 31 in combination in this modification.

Therefore, in the display panel having the configuration shown in FIG. 8, the side surface of the lens unit 31 facing the light source unit 41 is roughened so as to have the same configuration as the side surface 30s of the light guide plate 30 described with reference to FIG. 6. Namely, the side surface 30s of the light guide plate 30 in FIG. 6 is read as the side surface 31s of the lens unit 31, and the side surface 31s is configured so as to obtain the predetermined relationship in surface roughness with respect to the side surfaces of the light guide plate 30 other than the side surface 30s.

### Modification 2

Further, as shown in FIG. 9, it is also possible to form a display panel P10 in which another substrate 10, another liquid crystal layer LOL, another counter substrate 20, another light guide plate 30, another side light source device 40 (light source unit 41), and another control unit 60 are provided on the back surface 10b of the substrate 10. Namely, it can be said that the display panel P10 is obtained by bonding the back surfaces 10b of the substrates 10 of the two display panels P1 to each other.

Even in this configuration of the display panel P10, an observer on one side of the display panel P10 can visually recognize the background on the opposite side through the display panel P10, and can also recognize and observe the image on the side where the observer is present. Furthermore, an observer on the other side of the display panel P10 can visually recognize the background on the opposite side through the display panel P10, and can also recognize and appreciate the image on the side where the observer is present.

In these image displays, the same image can be displayed on only one surface, or different images can be displayed on both surfaces at the same time. However, when displaying the images on both surfaces at the same time, since the images displayed on the side of the front surface 10f of the substrate 10 and on the side of the back surface 10b of the substrate 10 can be recognized respectively, the observer sees the reversed images overlapping each other if the images are displayed in the mode in which the background is transparent, and this interferes with recognition and observation of the images and the like desired to be delivered in some cases. Therefore, when displaying the images on both surfaces at the same time, it is preferable that images are displayed so as not to interfere with each other or the density of background color is increased such that the displayed image on the side of the observer cannot be observed or is difficult to be observed.

In this display panel P10, it is preferable that each of the side surfaces 30s of the light guide plates 30 provided on both sides is roughened such that the generation of stripe-shaped light is suppressed in the light entrance side regions ELA in both of the image displays.

Next, the present embodiment will be described in further detail by using implementation configuration examples of the present embodiment and a comparative configuration example.

### Comparative Configuration Example

A display panel C1 serving as a comparative configuration example was prepared so as to have the configuration shown in FIG. 4 except that the side surfaces of the light guide plate 30 were all made to have approximately the same surface roughness (the side surface 30s was not roughened). In this display panel C1 used here, the thickness of the substrate 10 was 500 μm, the thickness of the counter substrate 20 was 700 μm, and the thickness of the light guide plate 30 was 2750 μm, and the side surfaces of the light guide plate 30 all had the surface roughness Ra of 0.02 μm and the surface roughness Rz of 0.2 μm. Further, as the light source unit 41, LEDs of blue, red, and green were arranged in order.

When the light source light from the LED was made to enter the light guide plate 30 in this display panel C1, a plurality of stripe-shaped lights corresponding to the used LEDs was observed in the light entrance side region ELA as shown in FIG. 11.

### Implementation Configuration Examples 1 and 2

Display panels serving as implementation configuration examples were prepared so as to have the configuration shown in FIG. 4. In the implementation configuration examples, a display panel 1 having the same configuration as the display panel C1 except that the side surface 30s of the light guide plate 30 facing the light source unit 41 was roughened and a display panel 2 having the same configuration as the display panel 1 except that the thickness of the light guide plate 30 was 5000 μm were prepared.

At this time, as to the side surfaces of the light guide plate 30, only the side surface 30s facing the light source unit 41 was roughened (the surface roughness Ra of the side surface 30s was 0.1 to 1.5 μm and the surface roughness Rz was 1.5 to 9.5 μm), and the side surfaces other than the side surface 30s each had the surface roughness Ra of 0.02 μm and the surface roughness Rz of 0.05 to 0.2 μm.

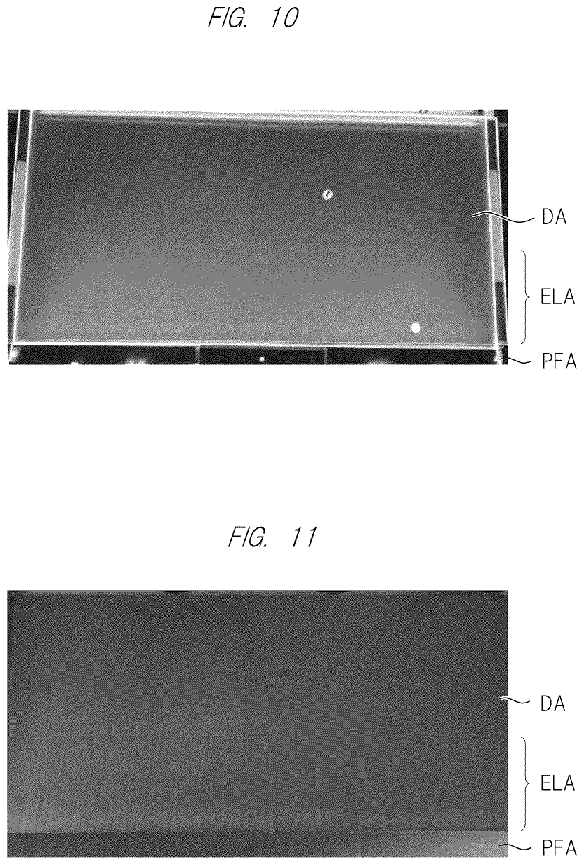

When the light source light from the LED was made to enter the light guide plate 30 in the display panels 1 and 2, almost no stripe-shaped light corresponding to the arranged LEDs was observed in the light entrance side region ELA as shown in FIG. 10, and it was confirmed that the generation of stripe-shaped light could be suppressed. In addition, in the above configurations, it was confirmed that the brightness gradient between the light entrance side region ELA and the other regions was improved in the display panel 2 as compared with the display panel 1. It was thought that this was because the improvement in brightness caused by the light source light scattered due to the surface roughness of the side surface 30s serving as the light entrance portion was alleviated by increasing the thickness of the light guide plate 30 and the brightness difference (brightness gradient) between the light entrance side region ELA and the other regions was reduced.

As described in the embodiment and modifications above, the surface roughness of the side surface 30s of the light guide plate 30 facing the light source unit 41 and the surface roughnesses of the side surfaces of the light guide plate 30 other than the side surface 30s are set to have a predetermined relationship, whereby the generation of stripe-shaped light in the light entrance side region of the light guide plate 30 can be suppressed and the brightness gradient between the light entrance side region and the other display regions can be improved, and it is possible to improve the quality of the display image.

In the foregoing, the embodiment and typical modifications have been described. However, the technique described above can be applied to various modifications other than the above-described modifications. For example, the above-described modifications may be combined.

A person having ordinary skill in the art can make various alterations and corrections within a range of the idea of the present invention, and it is interpreted that the alterations and corrections also belong to the scope of the present invention. For example, the embodiment obtained by performing addition or elimination of components or design change or the embodiment obtained by performing addition or reduction of process or condition change to the embodiment described above by a person having an ordinary skill in the art is also included in the scope of the present invention as long as it includes the gist of the present invention.

The present invention can be applied to display devices and electronic devices incorporating display devices.

What is claimed is:

1. A display device comprising:
a first substrate having a first front surface and a first back surface opposite to the first front surface;
a liquid crystal layer arranged on the first front surface of the first substrate;
a light guide plate having a first main surface facing the first front surface, a second main surface opposite to the first main surface, and side surfaces intersecting with the first main surface and the second main surface; and
a light source unit having a plurality of light emitting elements arranged to face the side surface of the light guide plate,
wherein a surface roughness of a first side surface of the light guide plate facing the light source unit is larger than surface roughnesses of the side surfaces other than the first side surface.

2. The display device according to claim 1,
wherein the side surfaces other than the first side surface are mirror surfaces.

3. The display device according to claim 1,
wherein a surface roughness Ra of the first side surface is 0.1 to 1.5 μm.

4. The display device according to claim 1,
wherein a surface roughness Rz of the first side surface is 1.5 to 9.5 μm.

5. The display device according to claim 2,
wherein a surface roughness Ra of each of the side surfaces other than the first side surface is 0.2 μm or less.

6. The display device according to claim 2,
wherein a surface roughness Rz of each of the side surfaces other than the first side surface is 0.05 to 0.2 μm.

7. The display device according to claim 1, further comprising a counter substrate arranged between the liquid crystal layer and the light guide plate so as to face the first substrate with the liquid crystal layer interposed therebetween,
wherein a thickness of the light guide plate is 3 to 6.5 mm, a thickness of the first substrate is 0.5 to 0.7 mm, and a thickness of the counter substrate is 0.5 to 0.7 mm.
